(19) United States
(12) Patent Application Publication
(10) Pub. No.: US 2025/0378804 A1
(43) Pub. Date: Dec. 11, 2025

(54) DRUMHEAD FASTENING DEVICE AND DRUM

(71) Applicant: YAMAHA CORPORATION, Hamamatsu-shi (JP)

(72) Inventor: Keizo HARADA, Hamamatsu-shi (JP)

(21) Appl. No.: 19/229,160

(22) Filed: Jun. 5, 2025

(30) Foreign Application Priority Data
Jun. 10, 2024 (JP) 2024-093695

(51) Int. Cl. G10D 13/16; G10D 13/10; G10D 13/20; G10D 13/22

(52) U.S. Cl. CPC G10D 13/16; G10D 13/20; G10D 13/22; G10D 13/26

(57) ABSTRACT

A drumhead fastening device is used for attaching a drumhead to an open end of a shell. The drumhead fastening device includes a plurality of lugs. Each of the plurality of lugs includes a lug main body fixed to the shell and a lug nut attached to the lug main body. The drumhead fastening device further includes a plurality of lug bolts corresponding to the plurality of lugs, respectively. Each of the plurality of lug bolts is screw coupled with the lug nut of the corresponding lug. At least one lug of the plurality of lugs includes a fixed lug nut fixed immovably to the lug main body. At least one lug of the plurality of lugs includes a movable lug nut movably attached to the lug main body.

### CROSS-REFERENCE TO RELATED APPLICATIONS

The present application claims priority to Japanese Patent Application No. 2024-093695, filed Jun. 10, 2024, the content of which is incorporated herein by reference.

### BACKGROUND OF THE INVENTION

### Field of the Invention

The present disclosure relates to a drumhead fastening device and a drum.

### Description of the Related Art

Japanese Patent No. 4642874 (hereinafter Patent Document 1) discloses a drumhead fastening device for attaching a drumhead to an open end of a cylindrical shell. The drumhead fastening device has multiple lugs that are provided on the outer periphery of the shell and arranged circumferentially around the shell, and multiple lug bolts that are screwed into lug nuts of each lug. The drumhead is attached to the shell by engaging the multiple lug bolts with a hoop that is externally attached to the open end of the shell, and then screwing the lug bolts into the respective lugs, whereby the drumhead is pressed against the open end of the shell by the hoop.

In the drumhead fastening device of Patent Document 1, each of the multiple lugs includes a lug main body that is fixed to the shell, and a lug nut into which a lug bolt is screwed. In Patent Document 1, in all lugs, a lug nut is movably attached relative to the lug main body. This prevents damage to the drum resulting from dimensional inaccuracies in drum components when mounting the drumhead.

### SUMMARY OF THE INVENTION

Incidentally, some drums require lug bolts to be removed from the lugs when the drumhead is detached from the shell. Also, during drum manufacturing, it is necessary to attach all lug bolts to the lugs. Consequently, if the lug nuts are movable relative to the lug main bodies in all lugs, it becomes difficult to attach the lug bolts to the lug nuts for all lugs when attaching the drumhead, such as during drumhead replacement or drum manufacturing. As a result, attaching the drumhead becomes cumbersome.

The present disclosure takes into consideration the above circumstances, with an object of providing a drumhead fastening device that facilitates easy attachment of a drumhead, along with a drum including the device.

A first aspect of the present disclosure is a drumhead fastening device for attaching a drumhead to an open end of a shell. The drumhead fastening device includes a plurality of lugs. Each of the plurality of lugs includes a lug main body fixed to the shell and a lug nut attached to the lug main body. The drumhead fastening device further includes a plurality of lug bolts corresponding to the plurality of lugs, respectively. Each of the plurality of lug bolts is screw coupled with the lug nut of the corresponding lug. At least one lug of the plurality of lugs includes a fixed lug nut fixed immovably to the lug main body. At least one lug of the plurality of lugs includes a movable lug nut movably attached to the lug main body.

A second aspect of the present disclosure is a drum including a drumhead fastening device including a plurality of lugs and a plurality of lug bolts corresponding to the plurality of lugs, respectively. Each of the plurality of lugs includes a plurality of lug nuts, respectively. The drum further includes: a shell to which the plurality of lugs are attached; a hoop that is attached to an open end of the shell; and a drumhead attached to the shell by the plurality of lug bolts being engaged with the hoop and being screw coupled with the plurality of lug nuts. Each of the plurality of lugs further comprises a lug main body fixed to the shell. At least one lug of the plurality of lugs includes a fixed lug nut fixed immovably to the lug main body. At least one lug of the plurality of lugs includes a movable lug nut movably attached to the lug main body.

### BRIEF DESCRIPTION OF THE DRAWINGS

FIG. 1 is a perspective view showing the exterior of a drum according to an embodiment of the present disclosure.

FIG. 2 is a plan view showing the drum of FIG. 1.

FIG. 3 is an enlarged cross-sectional view showing a lug including a fixed lug nut and its surrounding area in the drum of FIG. 1 and FIG. 2.

FIG. 4 is a cross-sectional view along the section line IV-IV in FIG. 3.

FIG. 5 is an enlarged perspective view showing the lug including the fixed lug nut and its surrounding area in the drum shown in FIG. 1 and FIG. 2.

FIG. 6 is an enlarged cross-sectional view showing the lug including a movable lug nut and its surrounding area in the drum of FIG. 1 and FIG. 2.

FIG. 7 is a cross-sectional view along the section line VII-VII in FIG. 6.

FIG. 8 is a plan view showing a drum according to another embodiment of the present disclosure.

### DESCRIPTION OF THE EMBODIMENTS

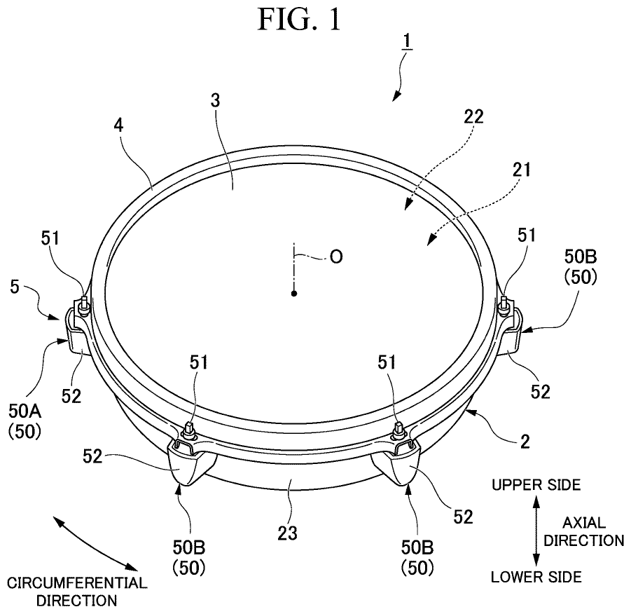

Hereinafter, embodiments of the present disclosure will be described, with reference to FIG. 1 through FIG. 7.

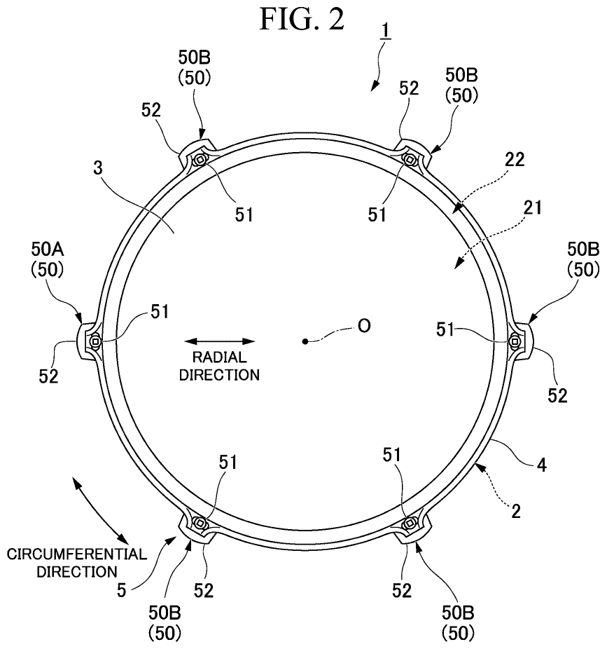

As shown in FIG. 1 and FIG. 2, a drum 1 of the present embodiment includes a shell 2, a drumhead 3, a hoop 4, and a drumhead fastening device 5.

The shell 2 is formed in a cylindrical shape. Multiple lugs 50 are attached to the shell 2 and are provided on the drumhead fastening device 5, which will be described later. The shell 2 of the present embodiment has an internal space 21 and one open end 22 that opens the internal space 21 to the outside. The open end 22 of the shell 2 is formed in a circular shape. The shell 2 also has a ring-shaped peripheral wall part 23 that forms the open end 22. The shell 2 of the present embodiment is made of a non-conductive material, such as plastic. It should be noted that the shell 2 may be made of a conductive material such as a metal.

In the following description, the direction along which the axis O of the peripheral wall part 23 of the shell 2 extends is referred to as the axial direction. Moreover, the direction extending outward from the axis O is referred to as the radial direction, and the direction encircling the axis O is referred to as the circumferential direction. Furthermore, one side in the axial direction where the open end 22 of the shell 2 opens is referred to as the upper side or upward direction, and the other side in the axial direction is referred to as the lower side or downward direction.

The drumhead 3 is formed in a circular shape corresponding to the shape of the open end 22 of the shell 2 when viewed from above, and is attached to the open end 22 of the shell 2 so as to cover the open end of the shell 2. The hoop 4 is formed in an annular shape to correspond to the open end 22 of the shell 2, and is externally fitted onto the open end 22 of the shell 2. The hoop 4 presses the drumhead 3 against the open end 22 of the shell 2 using the drumhead fastening device 5, which will be described later.

The hoop 4 of the present embodiment is made of a conductive material such as a metal. Although not shown in the drawings, the hoop 4 of the present embodiment has multiple insertion holes formed therethrough in the axial direction, through which lug bolts 51 of the drumhead fastening device 5, which will be described later, are inserted. The multiple insertion holes are arranged at equal intervals around the circumferential direction of the hoop 4. In the drum 1 shown in FIG. 1 and FIG. 2, the number of insertion holes in the hoop 4 corresponds to the number of lug bolts 51, which will be described later. Although not shown in the drawings, each insertion hole of the hoop 4 is formed as an elongated hole extending in the circumferential direction.

The drumhead fastening device 5 is a device for attaching the drumhead 3 to the open end 22 of the shell 2. The drumhead fastening device 5 includes multiple lugs 50 and multiple lug bolts 51. The multiple lugs 50 are arranged at equal intervals around the circumferential direction of the shell 2. The number of the lugs 50 corresponds to the number of the lug bolts 51. The number of the lugs 50 and the number of the lug bolts 51 in FIG. 1 and FIG. 2 is six, but it is not limited to this number.

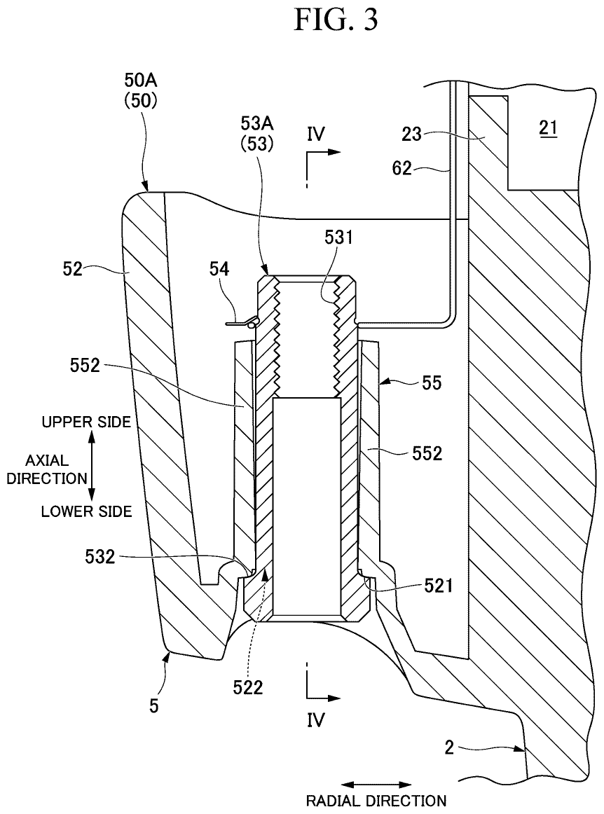

As shown in FIG. 3 to FIG. 7, each lug 50 includes a lug main body 52 and a lug nut 53.

The lug main body 52 is fixed to the shell 2 mentioned above. The lug main body 52 in the present embodiment is formed integrally with the shell 2. For this reason, the lug main body 52 is made of the same non-conductive material as that of the shell 2.

In the present embodiment, each lug main body 52 has a spherical inner surface 521. In the present embodiment, the spherical inner surface 521 faces downward in the axial direction. Each lug main body 52 has a nut insertion hole 522 through which the lug nut 53 is inserted in the axial direction. The lower end of the nut insertion hole 522 opens into the spherical inner surface 521 mentioned above.

The lug nut 53 is attached to the lug main body 52. The lug nut 53 is made of a conductive material such as metal, and has a female thread 531 for screwing the lug bolt 51 thereinto.

In the present embodiment, the lug nut 53 has a spherical outer surface 532 that is in surface contact with the spherical inner surface 521 mentioned above. The spherical outer surface 532 is positioned at the lower end of the lug nut 53 when the lug nut 53 is attached to the lug main body 52, and faces upward in the axial direction. Therefore, the lug nut 53 passes upward through the nut insertion hole 522 of the lug main body 52, and thereby the lower end of the lug nut 53 engages the spherical inner surface 521 of the lug main body 52.

A retaining ring 54 is attached on the upper end of the lug nut 53 that passes through the nut insertion hole 522 of the lug main body 52. The retaining ring 54 prevents the lug nut 53 from detaching from the lug main body 52.

The multiple lug bolts 51 shown in FIG. 1 and FIG. 2 are screwed into the lug nuts 53 of the multiple lugs 50 mentioned above, respectively. The lug bolts 51 are made of a conductive material such as metal.

In the drum 1, the multiple lug bolts 51 are engaged with the hoop 4 and screwed into the respective lug nuts 53. Consequently, the hoop 4 presses the drumhead 3 against the open end 22 of the shell 2, thus attaching the drumhead 3 to the shell 2.

In the drum 1 of the present embodiment, the head of each lug bolt 51 engages with the hoop 4 when the main body part of each lug bolt 51 is inserted into the insertion hole of the hoop 4. It should be noted that the hoop 4 need not have an insertion hole formed therein. In such a case, each lug bolt 51 need only have a hook provided on its head for engagement with the hoop 4.

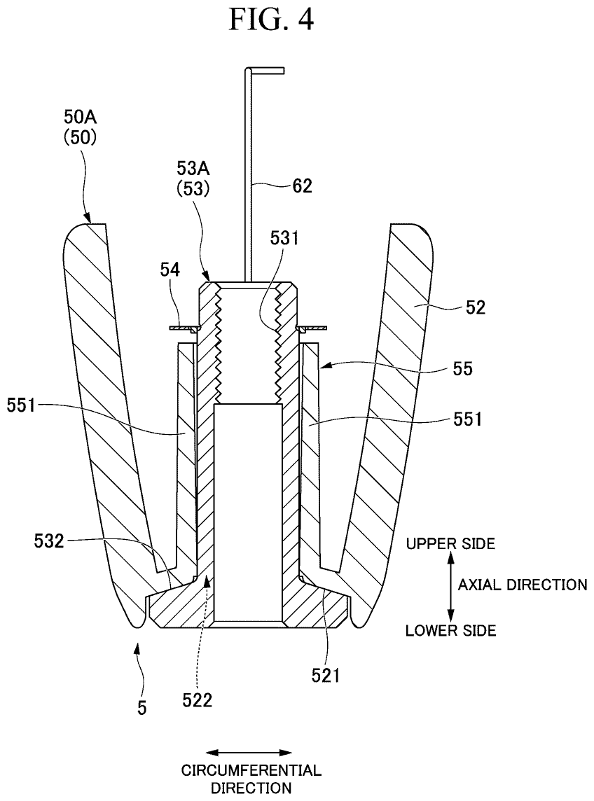

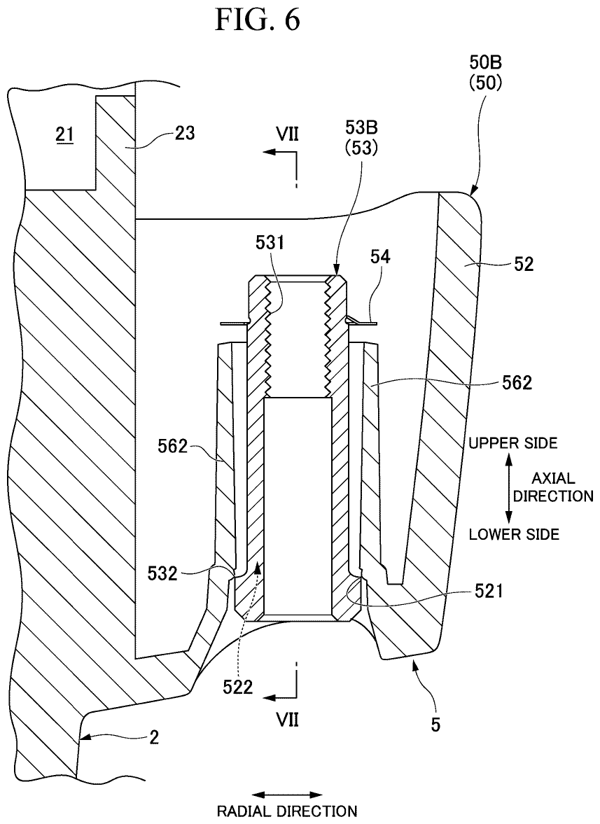

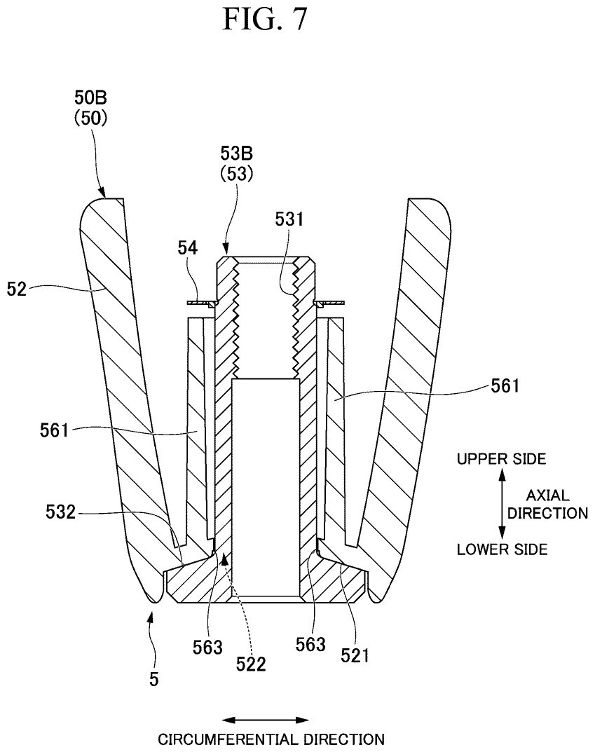

In the drumhead fastening device 5, multiple lug nuts 53 are provided including the fixed lug nut 53A shown in FIG. 3 and FIG. 4, and the movable lug nut 53B shown in FIG. 6 and FIG. 7. The fixed lug nut 53A is a lug nut fixed immovably to the lug main body 52. The movable lug nut 53B is a lug nut attached movably to the lug main body 52. The number of the fixed lug nuts 53A and the movable lug nuts 53B may each be at least one or more.

In the following description, the lug 50 including the fixed lug nut 53A will be referred to as the fixed lug 50A, and the lug 50 including the movable lug nut 53B will be referred to as the movable lug 50B.

As shown in FIG. 3 and FIG. 4, the spherical outer surface 532 of the fixed lug nut 53A makes surface contact with the spherical inner surface 521 of the lug main body 52 and slides against the spherical inner surface 521, thereby allowing the fixed lug nut 53A (the upper portion of the fixed lug nut 53A) to move relative to the lug main body 52 in both the radial and circumferential directions of the shell 2.

However, the lug main body 52 of the fixed lug 50A, to which the fixed lug nut 53A is attached, has a fixing part 55 that prevents radial and circumferential movement of the fixed lug nut 53A.

The fixing part 55 includes circumferential-direction-fixing parts 551 and radial-direction-fixing parts 552.

The circumferential-direction-fixing parts 551 are arranged on both sides of the fixed lug nut 53A, which is inserted through the nut insertion hole 522, in the circumferential direction. The spacing between the circumferential-direction-fixing parts 551 in the circumferential direction is approximately the same as the dimension of the fixed lug nut 53A in the circumferential direction. This prevents the fixed lug nut 53A from moving in the circumferential direction.

The radial-direction-fixing parts 552 are arranged on both sides of the fixed lug nut 53A, which is inserted through the nut insertion hole 522, in the radial direction. The spacing between the radial-direction-fixing parts 552 in the radial direction is approximately the same as the dimension of the fixed lug nut 53A in the radial direction. This prevents the fixed lug nut 53A from moving in the radial direction.

In the present embodiment, the circumferential-direction-fixing parts 551 and the radial-direction-fixing parts 552 are wall portions extending upward from the portion of the lug main body 52 forming the spherical inner surface 521.

As shown in FIG. 6 and FIG. 7, the spherical outer surface 532 of the movable lug nut 53B makes surface contact with the spherical inner surface 521 of the lug main body 52 and slides against the spherical inner surface 521, thereby allowing the movable lug nut 53B (the upper portion of the movable lug nut 53B) to move relative to the lug main body 52 in both the radial and circumferential directions of the shell 2.

However, the lug main body 52 of the movable lug 50B, to which the movable lug nut 53B is attached, has circumferential-direction-restricting parts 561 that restrict circumferential movement of the movable lug nut 53B. The lug main body 52 of the movable lug 50B also has a radial-direction-restricting parts 562 that restrict radial movement of the movable lug nut 53B.

The circumferential-direction-restricting parts 561 are arranged adjacent to both sides of the movable lug nut 53B inserted in the nut insertion hole 522, in the circumferential direction. The spacing between the main portions of the circumferential-direction-restricting parts 561 in the circumferential direction is greater than the dimension of the movable lug nut 53B in the circumferential direction. However, the circumferential-direction-restricting parts 561 have restricting protrusions 563 protruding from their main portion to make the spacing between the circumferential-direction-restricting parts 561 substantially equal to the circumferential dimension of the movable lug nut 53B. This prevents the movable lug nut 53B from moving in the circumferential direction. The radial-direction-restricting parts 562 are arranged adjacent to both sides of the movable lug nut 53B inserted in the nut insertion hole 522, in the radial direction. The spacing between the radial-direction-restricting parts 562 in the radial direction is greater than the dimension of the movable lug nut 53B in the radial direction. Therefore, the movable lug nut 53B (the upper portion of the movable lug nut 53B) is movable in the radial direction between the radial-direction-restricting parts 562. It should be noted that the lug main body 52 of the movable lug 50B need not include the radial-direction-restricting parts 562, for example.

As shown in FIG. 2, in the drumhead fastening device 5 of the present embodiment, the number of lugs 50 is six, and the number of the fixed lugs 50A including the fixed lug nut 53A, is one. Therefore, the number of movable lugs 50B including the movable lug nuts 53B, is five.

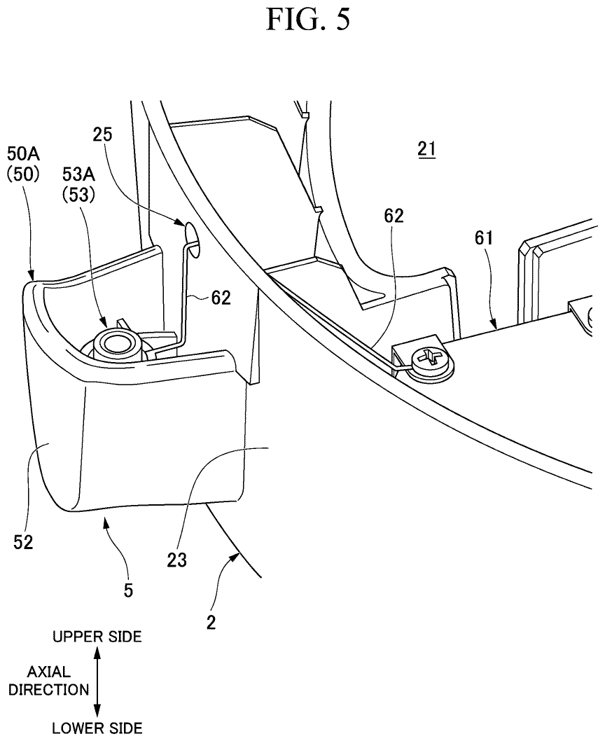

As shown in FIG. 5, in the drum 1 of the present embodiment, an electrical circuit 61 is arranged inside the shell 2 (in the internal space 21). The electrical circuit 61 may be, for example, an impact sensor unit that detects strikes on the drum 1 and outputs electric signals. A ground wire 62 extends from the electrical circuit 61. The ground wire 62 is connected to the fixed lug nut 53A described above. In the illustrated example, the ground wire 62 extends from the electrical circuit 61 inside the shell 2 to the fixed lug nut 53A outside the shell 2 by passing through a through hole 25 formed in the peripheral wall part 23. In FIG. 3 and FIG. 5, the ground wire 62 is attached to the upper end of the fixed lug nut 53A.

Since the fixed lug nut 53A, the lug bolt 51, and the hoop 4 are made of conductive materials such as metal, the ground wire 62 is electrically connected, via the fixed lug nut 53A, to the lug bolt 51 screwed into the lug nut 53 and to the hoop 4 engaged by the lug bolt 51. This helps suppress or prevent malfunctions in the electrical circuit 61 caused by static electricity. Therefore, even if the shell 2 and the lug main body 52 are made of non-conductive materials such as plastic or wood, malfunctions in the electrical circuit 61 caused by static electricity can be suppressed or prevented when the performer of the drum 1, charged with static electricity, touches conductive components such as the lug nut 53, the lug bolt 51, or the hoop 4.

As described above, in the drumhead fastening device 5 of the present embodiment and the drum 1 that includes it, at least one of the multiple lug nuts 53 is a fixed lug nut 53A, which is immovably fixed to the lug main body 52. Also, at least another one of the multiple lug nuts 53 is a movable lug nut, which is movably attached to the lug main body 52. In other words, some of the multiple lug nuts 53 are fixed lug nuts 53A, and the remaining lug nuts 53 that are not fixed lug nuts 53A are movable lug nuts 53B. As a result, in the drumhead fastening device 5 and the drum 1 that includes it, the lug bolt 51 can be easily attached to the fixed lug nut 53A, as compared to the movable lug nut 53B. Thus, compared to a case where all of the lug nuts 53 are movable lug nuts 53B, the drumhead 3 can be easily attached.

Furthermore, with some of the lug nuts 53 being movable lug nuts 53B, damage to the drum 1 caused by dimensional inaccuracies in components such as the hoop 4 during drumhead 3 attachment can also be avoided.

In addition, in the drumhead fastening device 5 of the present embodiment, the movable lug nut 53B has a spherical outer surface 532 that makes surface contact with the spherical inner surface 521 of the lug main body 52. The spherical outer surface 532 of the movable lug nut 53B slides against the spherical inner surface 521 of the lug main body 52, allowing the movable lug nut 53B (the upper portion of the movable lug nut 53B) to move radially and circumferentially relative to the lug main body 52. However, while the movable lug nut 53B (the upper portion of the movable lug nut 53B) can actively move in the radial direction of the shell 2, its movement in the circumferential direction is restricted by the circumferential-direction-restricting part 561. By restricting the movement direction of the movable lug nut 53B in this manner, the lug bolt 51 can be easily attached to the movable lug nut 53B, as compared to the case where its movement direction is not restricted.

Since the movable lug nut 53B (the upper portion of the movable lug nut 53B) can move relative to the lug main body 52 in the radial direction, the relative position between the lug bolt 51, which is screwed into the movable lug nut 53B, and the insertion hole in the hoop 4 through which the lug bolt 51 passes can be adjusted radially. Furthermore, in the present embodiment, since the insertion hole in the hoop 4 is an elongated hole extending circumferentially, the relative circumferential position between the lug bolt 51 screwed into the movable lug nut 53B and the insertion hole in the hoop 4 through which lug bolt 51 passes can be adjusted.

In addition, in the drumhead fastening device 5 of the present embodiment, the configuration of the lug main body 52 forming the fixed lug 50A (circumferential-direction-fixing part 551, radial-direction-fixing part 552), and the configuration of the lug main body 52 forming the movable lug 50B (circumferential-direction-restricting part 561, radial-direction-restricting part 562) determine the lug nut 53A that remains stationary relative to the lug main body 52 and the lug nut 53B that moves relative to it. Therefore, the fixed lug nut 53A and the movable lug nut 53B can be configured using lug nuts 53 of the same shape.

Moreover, in the drumhead fastening device 5 of the present embodiment, the ground wire 62 extending from the electrical circuit 61 arranged inside the shell 2 is connected to the fixed lug nut 53A. Therefore, the reliability of the electrical connection between the ground wire 62 and the lug nut 53 can be improved compared to the case where the ground wire 62 is connected to the movable lug nut 53B. In explanation of this point, the fixed lug nut 53A is immovable relative to the lug main body 52 (and the shell 2). As a result, the positional relationship between the electrical circuit 61, arranged inside the shell 2, and the fixed lug nut 53A remains unchanged. This suppresses or prevents the ground wire 62 from breaking or detaching from the fixed lug nut 53A or the electrical circuit 61 even in a case where the electrical circuit 61 and the fixed lug nut 53A are connected by the ground wire 62. Therefore, the reliability of the electrical connection between the ground wire 62 and the lug nut 53 can be improved.

It should be noted that in a case where the ground wire 62 is connected to the movable lug nut 53B, there is a higher risk of a malfunction where the ground wire 62 could break or detach from either the movable lug nut 53B or the electrical circuit 61, due to the movement of the movable lug nut 53B relative to the lug main body 52.

The present disclosure has been described in detail above, however, the present disclosure is not limited to the above embodiment, and various modifications may be made without departing from the scope of the present disclosure.

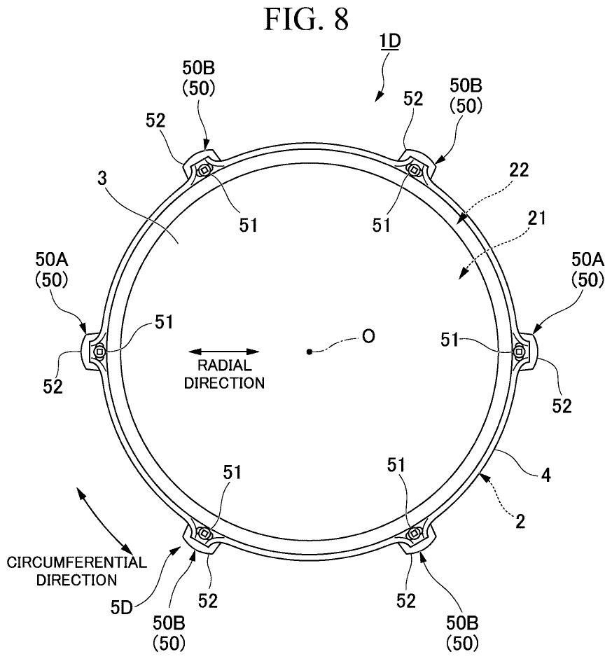

In the present disclosure, for example, as shown in a drum 1D and a drumhead fastening device 5D in FIG. 8, the number of fixed lugs 50A including fixed lug nuts 53A, may be two or more. In such a case, the two fixed lugs 50A may be positioned diagonally opposite to each other on the shell 2 when viewed along the axial direction of the shell 2. In order to position the two fixed lugs 50A diagonally opposite to each other on the shell 2, the number (total number) of lugs 50 needs to be an even number of at least four or more.

As exemplified in FIG. 8, in the case where two fixed lugs 50A are positioned diagonally opposite to each other on the shell 2, the drumhead 3 can be uniformly tensioned (stretched) at the open end 22 of the shell 2. This point will be described below.

Compared to the movable lug nut 53B, which moves relative to the lug main body 52, the fixed lug nut 53A, which remains stationary relative to the lug main body 52, allows for easier attachment of the lug bolt 51. As a result, when attaching the drumhead 3 to the open end 22 of the shell 2, attaching the lug bolt 51 to the fixed lug nut 53A before the movable lug nut 53B allows for more efficient attachment of the drumhead 3. Then, by positioning the two fixed lugs 50A including the fixed lug nut 53A, diagonally opposite to each other on the shell 2, the two lug bolts 51 are attached first to the two fixed lug nuts 53A positioned diagonally opposite to each other on the shell 2. This allows the drumhead 3 to be attached stably and reliably. Also, the drumhead 3 can be uniformly tensioned (stretched) at the open end 22 of the shell 2.

In the case where the two lugs 50 including the fixed lug nut 53A, are adjacent to each other in the circumferential direction of the shell 2, if the two lug bolts 51 are first attached to the two fixed lug nuts 53A during the attachment of the drumhead 3, it will become more difficult to attach the remaining lug bolts 51 to the movable lug nuts 53B, and/or the tensioning (stretching) of the drumhead 3 will become uneven.

In the present disclosure, the movable lug nut 53B may be configured such that movement in the radial direction is prevented and movement in the circumferential direction is allowed, for example. In such a case, the insertion hole in the hoop 4 through which the lug bolt 51 passes may be, for example, an elongated hole extending in the radial direction.

Furthermore, the movable lug nut 53B may, for example, be movable within a predetermined range in both circumferential and radial directions.

The present disclosure is not limited to a drum including the shell 2 with only one open end 22, and may be applied to, for example, a drum in which a shell is formed in a cylindrical shape and has two open ends.

According to the present disclosure, a drumhead can be effortlessly attached to a drum.

While preferred embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

What is claimed is:

1. A drumhead fastening device for attaching a drumhead to an open end of a shell, comprising:
a plurality of lugs, each of the plurality of lugs comprising a lug main body fixed to the shell and a lug nut attached to the lug main body; and
a plurality of lug bolts corresponding to the plurality of lugs, respectively, each of the plurality of lug bolts being screw coupled with the lug nut of the corresponding lug,
wherein at least one lug of the plurality of lugs includes a fixed lug nut fixed immovably to the lug main body, and
wherein at least one lug of the plurality of lugs includes a movable lug nut movably attached to the lug main body.

2. The drumhead fastening device according to claim 1,
wherein a number of the plurality of lugs included in the drumhead fastening device is an even number of four or more, and
wherein two lugs of the plurality of lugs include the fixed lug nut, the two lugs being positioned diagonally opposite to each other on the shell as viewed along an axial direction of the shell.

3. The drumhead fastening device according to claim 1,
wherein the lug main body of each lug of the plurality of lugs including the movable lug nut has a spherical inner surface,
wherein the movable lug nut has a spherical outer surface that is in surface contact with the spherical inner surface,
wherein the movable lug nut is movable relative to the lug main body in a radial direction and a circumferential direction of the shell by the spherical outer surface sliding against the spherical inner surface, thereby allowing the movable lug nut to move relative to the lug main body in the radial direction and the circumferential direction of the shell, and
wherein the lug main body of each lug of the plurality of lugs including the movable lug nut comprises circumferential-direction-restricting parts that are arranged adjacent to both sides of the movable lug nut in the circumferential direction and that restrict a movement of the movable lug nut in the circumferential direction.

4. The drumhead fastening device according to claim 1, wherein a ground wire extending from an electrical circuit arranged inside the shell is connected to the fixed lug nut of the at least one lug of the plurality of lugs including the fixed lug nut.

5. The drumhead fastening device according to claim 1, wherein the shell has a cylindrical shape.

6. A drum, comprising:
a drumhead fastening device comprising a plurality of lugs and a plurality of lug bolts corresponding to the plurality of lugs, respectively, each of the plurality of lugs comprising a plurality of lug nuts, respectively;
a shell to which the plurality of lugs are attached;
a hoop that is attached to an open end of the shell; and
a drumhead attached to the shell by the plurality of lug bolts being engaged with the hoop and being screw coupled with the plurality of lug nuts,
wherein each of the plurality of lugs further comprises a lug main body fixed to the shell,
wherein at least one lug of the plurality of lugs includes a fixed lug nut fixed immovably to the lug main body, and
wherein at least one lug of the plurality of lugs includes a movable lug nut movably attached to the lug main body.

7. The drum according to claim 6, wherein the shell has a cylindrical shape.
